(19) United States
(12) Patent Application Publication
(10) Pub. No.: US 2010/0202167 A1
(43) Pub. Date: Aug. 12, 2010

(54) SOFT SWITCHING POWER CONVERTER WITH A VARIABLE SWITCHING FREQUENCY FOR IMPROVING OPERATION AND EFFICIENCY

(75) Inventor: TA-YUNG YANG, MILPITAS, CA (US)

Correspondence Address: ROSENBERG, KLEIN & LEE, 3458 ELLICOTT CENTER DRIVE-SUITE 101, ELLICOTT CITY, MD, 21043, US

(73) Assignee: SYSTEM GENERAL CORP., TAIPEI HSIEN (TW)

(21) Appl. No.: 12/645,585

(22) Filed: Dec. 23, 2009

Related U.S. Application Data
(60) Provisional application No. 61/207,335, filed on Feb. 10, 2009.

(51) Int. Cl. H02M 3/337

(52) U.S. Cl. 363/26

(57) ABSTRACT

A power converter according to the present invention comprises a resonant tank. The resonant tank is switched by a plurality of transistors. A control circuit generates a plurality of switching signals to control the transistors. The pulse widths of the switching signals are modulated for regulating an output voltage of the power converter. The control circuit is coupled to detect an input voltage of the power converter. The frequency of the switching signals is changed in response to the change of the input voltage or/and an output load of the power converter.

### BACKGROUND OF THE INVENTION

1. Field of the Invention

The present invention relates to power converters, and more particularly, relates to the soft switching power converters.

2. Description of the Related Art

The phase shift power converter is a soft switching power converter including full-bride phase shift, asymmetrical half bridge and active clamp topologies, etc. The advantages of the phase shift power converter are high efficiency and low EMI. In recent developments, many phase-shift technologies have been proposed, such as “Constant frequency resonant power converter with zero voltage switching” by Christopher, P. Henze, Ned Mohan, and John G Hayes, U.S. Pat. No. 4,855,888, Aug. 8, 1989; “Soft-switching PWM converters” by Guichao C. Hua and Fred C. Lee, U.S. Pat. No. 5,442,540, Aug. 15, 1995; “Soft-switched full-bridge converters” by Yungtaek Jang and Milan M. Jovanovic, U.S. Pat. No. 6,356,462, Mar. 12, 2002; and “Asymmetrical power converter and method of operation thereof” by Rui Liu, U.S. Pat. No. 6,069,798, May 30, 2000. In various phase shift power converters, the parasitic leakage inductance of the transformer and/or additional magnetic components is employed as a resonant inductance. It is switched to generate the circulating current for achieving zero voltage switching (ZVS).

However, the drawback of these phase shift power converters is its narrow operation range. The object of the present invention is to provide a control scheme to extend its operation range and further improve its efficiency.

### BRIEF SUMMARY OF THE INVENTION

A power converter is developed to extend its operation range and further improve its efficiency. The power converter comprises a resonant tank, a plurality of transistors and a control circuit. The transistors are coupled to switch the resonant tank. The control circuit generates a plurality of switching signals to control the transistors. The pulse widths of the switching signals are modulated for regulating an output voltage of the power converter. The control circuit is coupled to detect an input voltage of the power converter. The frequency of the switching signals is changed in response to the change of the input voltage or/and an output load of the power converter.

### BRIEF DESCRIPTION OF THE DRAWINGS

The invention can be more fully understood by reading the subsequent detailed description and examples with references made to the accompanying drawings, wherein:

FIG. 1 shows a circuit diagram of a preferred embodiment of a power converter in accordance with the present invention.

FIG. 2 shows a circuit diagram of a preferred embodiment of the control circuit in accordance with the present invention.

FIG. 3 shows a circuit diagram of a preferred embodiment of the oscillator in accordance with the present invention.

FIG. 4 shows a circuit diagram of a preferred embodiment of the frequency modulation circuit in accordance with the present invention.

FIG. 5 shows a circuit diagram of a preferred embodiment of the frequency generation circuit in accordance with the present invention.

FIG. 6 is a circuit diagram of a preferred embodiment of the PWM circuit in accordance with the present invention.

FIG. 7 shows a circuit diagram of a preferred embodiment of the blanking circuit in accordance with the present invention.

FIG. 8 is a circuit diagram of a preferred embodiment of the output circuit in accordance with the present invention.

FIG. 9 shows a circuit diagram of a preferred embodiment of delay time circuits in accordance with the present invention.

FIG. 10 shows a transfer function chart that shows the gain versus the change of the switching frequency.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

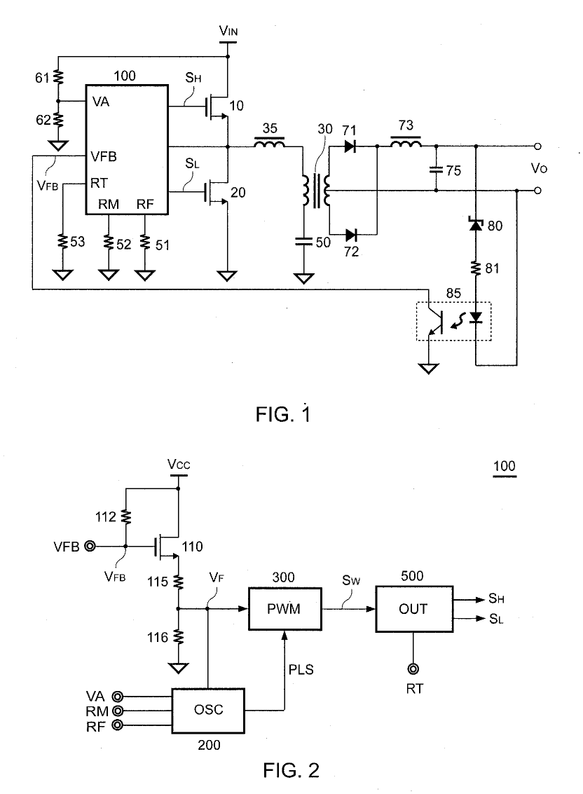

FIG. 1 is a power converter in accordance with the present invention. A capacitor 50 and an inductive device (such as a transformer 30, its parasitic inductor 35 and the load) develop a resonant tank. The capacitor 50 is connected from a terminal of the primary winding of the transformer 30 to the ground. Therefore, the capacitor 50 is coupled to the inductive device. Transistors 10 and 20 are coupled to switch the resonant tank. A drain terminal of the transistor 10 is coupled to an input voltage V_{IN}. A source terminal of the transistor 10 is connected to a drain terminal of the transistor 20. The source terminal of the transistor 10 and the drain terminal of the transistor 20 are connected to another terminal of the primary winding of the transformer 30 via its parasitic inductor 35. A source terminal of the transistor 20 is coupled to the ground. Two rectifiers 71 and 72 are connected from the secondary winding of the transformer 30 to an output voltage V_{O} of the power converter through an inductor 73. The output voltage V_{O} is generated at a capacitor 75.

A control circuit 100 generates switching signals S_{H} and S_{L} coupled to gate terminals of the transistors 10 and 20 to control the transistors 10 and 20 respectively. The pulse widths of the switching signals S_{H} and S_{L} are modulated in accordance with a feedback signal V_{FB} for regulating the output voltage V_{O} of the power converter. The feedback signal V_{FB} is generated at a VFB terminal. A zener diode 80, a resistor 81 and an optocoupler 85 form a feedback circuit coupled to the output voltage V_{O} of the power converter to generate the feedback signal V_{FB}. Furthermore, a VA terminal of the control circuit 100 is coupled to detect the input voltage V_{IN} of the power converter via resistors 61, 62. The resistor 61 is connected to the input voltage V_{IN}, and the resistor 62 is connected to the resistor 61 in series. The VA terminal of the control circuit 100 is connected to a joint of the resistors 61 and 62. The frequency of the switching signals S_{H} and S_{L} is changed in response to the change of the input voltage V_{IN} and the feedback signal V_{FB}, which will allow the power converter to operate in a wide range.

The frequency of the switching signals S_{H} and S_{L} is decreased in response to the decrease of the input voltage V₁. The frequency of the switching signals S_{H} and S_{L} is also decreased in response to the increase of the feedback signal V_{FB}. The change of the feedback signal V_{FB} is correlated to the change of the output load of the power converter. Therefore, the control circuit 100 is coupled to detect the output load of the power converter for decreasing the frequency of the switching signals S_{H} and S_{L} in response to the increase of the output load of the power converter. A resistor 53 is connected to a RT terminal of the control circuit 100 to determine delay times. The delay times are inserted between the switching signals S_{H} and S_{L} for achieving soft switching of the transistors 10, 20. Therefore, the control circuit 100 further generates the delay times for achieving soft switching. The resistor 53 serves as a delay-time resistor for determining the delay times of the switching signals S_{H} and S_{L}. A resistor 51 is connected to a RF terminal of the control circuit 100 to determine the maximum frequency of the switching signals S_{H} and S_{L}. The resistor 51 serves as a frequency-setting resistor for determining the maximum switching frequency of the switching signals S_{H} and S_{L}. Another resistor 52 coupled to a RM terminal of the control circuit 100 is applied to determine the minimum switching frequency of switching signals S_{H} and S_{L}. The resistor 52 serves as a frequency-modulation resistor for determining the minimum switching frequency of the switching signals S_{H} and S_{L}.

FIG. 2 is a preferred embodiment of the control circuit 100 in accordance with the present invention. It includes a feedback-input circuit coupled to the output voltage V_{O} to receive the feedback signal V_{FB} and generate a level-shift signal V_{F}. The level-shift signal V_{F} is correlated to the feedback signal V_{FB}. A transistor 110 and resistors 112, 115, and 116 develop the feedback-input circuit. A drain terminal of the transistor 110 is coupled to receive a supply voltage V_{CC}. A gate terminal of the transistor 110 is coupled to the VFB terminal to receive the feedback signal V_{FB}. The resistor 112 is connected from the drain terminal of the transistor 110 to the gate terminal of the transistor 110. The resistor 115 is connected to a source terminal of the transistor 110. The resistor 116 is connected from the resistor 115 to the ground.

An oscillator (OSC) 200 is coupled to detect the level-shift signal V_{F} and the input voltage V_{IN} (via the VA terminal) for generating an oscillation signal PLS. Therefore, the oscillator 200 detects the feedback signal V_{FB} and the input voltage V_{IN} for generating the oscillation signal PLS. The resistor 51 at the RF terminal and the resistor 52 at the RM terminal are also coupled to the oscillator 200 for determining the maximum frequency and the minimum frequency of the oscillation signal PLS. A PWM circuit (PWM) 300 is coupled to the oscillator 200 to generate a PWM signal S_{W} in response to the oscillation signal PLS. The pulse width of the PWM signal S_{W} is modulated by the PWM circuit 300 in accordance with the level-shift signal V_{F}. Therefore, the pulse width of the PWM signal S_{W} is modulated in accordance with the feedback signal V_{FB}.

An output circuit (OUT) 500 is coupled to the PWM circuit 300 to generate the switching signals S_{H} and S_{L} in accordance with the PWM signal S_{W}. Besides, the delay times are inserted into the switching signals S_{H}, S_{L} for achieving soft switching of the transistors 10, 20. The resistor 53 at the RT terminal is coupled to the output circuit 500 for determining the value of the delay times. The delay times include a first delay time and a second delay time. The first delay time is generated after the switching signal S_{H} is turned off and before the switching signal S_{L} is turned on. The second delay time is generated after the switching signal S_{L} is turned off and before the switching signal S_{H} is turned on.

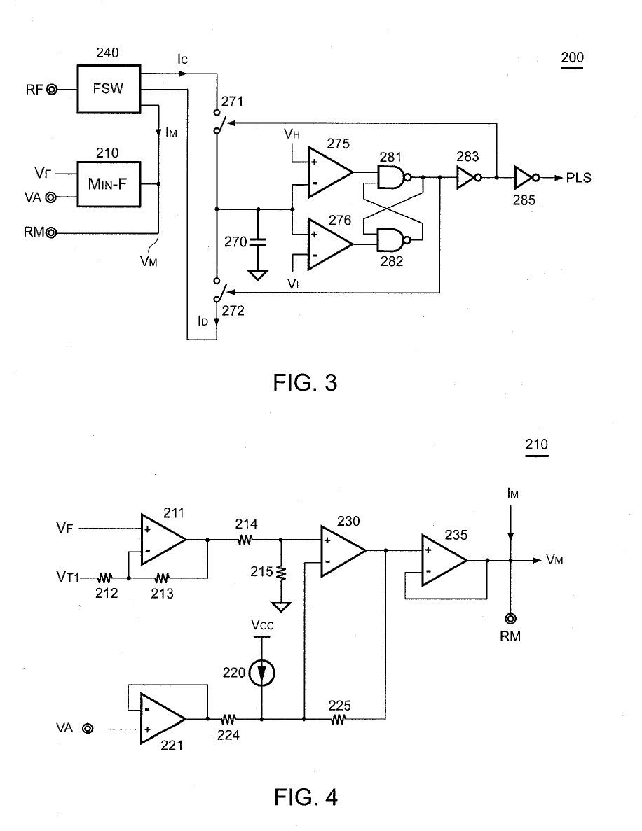

FIG. 3 is a preferred embodiment of the oscillator 200 in accordance with the present invention. The oscillator 200 includes a frequency modulation circuit (M_{IN}-F) 210, a frequency generation circuit (FSW) 240 and an oscillation circuit. The frequency modulation circuit 210 is coupled to the VA terminal and receives the level-shift signal V_{F}. The frequency modulation circuit 210 generates a frequency modulation signal V_{M} in accordance with the feedback signal V_{FB} and the input voltage V_{IN}. The frequency generation circuit 240 generates a charge current I_{C} and a discharge current I_{D} in accordance with the resistor 51 and the frequency modulation signal V_{M}. As shown in FIG. 1, the resistor 51 is coupled to the RF terminal of the control circuit 100. The frequency generation circuit 240 also generates a modulation current I_{M} to charge the RM terminal and flows through the resistor 52. As shown in FIG. 1, the resistor 52 is coupled to the RM terminal of the control circuit 100.

The oscillation circuit is developed by a capacitor 270, switches 271, 272, comparators 275, 276, NAND gates 281, 282 and inverters 283, 285. A first terminal of the switch 271 receives the charge current I_{C} for charging the capacitor 270. A second terminal of the switch 271 is coupled to a first terminal of the switch 272 and a first terminal of the capacitor 270. A second terminal of the switch 272 receives the discharge current I_{D} for discharging the capacitor 270. A second terminal of the capacitor 270 is coupled to the ground. A positive input of the comparator 275 receives an upper-limit threshold V_{H}. Both a negative input of the comparator 275 and a positive input of the comparator 276 are coupled to the first terminal of the capacitor 270, the second terminal of the switch 271 and the first terminal of the switch 272. A negative input of the comparator 276 receives a lower-limit threshold V_{L}. The upper-limit threshold V_{H} is higher than the lower-limit threshold V_{L}.

A first terminal of the NAND gate 281 is coupled to an output of the comparator 275. A first terminal of the NAND gate 282 is coupled to an output of the comparator 276. An output of the NAND gate 281 is coupled to a second terminal of the NAND gate 282. An output of the NAND gate 282 is coupled to a second terminal of the NAND gate 281. An input of the inverter 283 is coupled to the output of the NAND gate 281 and controls the switch 272. An input of the inverter 285 is coupled to an output of the inverter 283 and controls the switch 271. An output of the inverter 285 generates the oscillation signal PLS. Therefore, the oscillation circuit is coupled to receive the charge current I_{C} and the discharge current I_{D} for generating the oscillation signal PLS.

FIG. 4 shows a preferred embodiment of the frequency modulation circuit 210 in accordance with the present invention. The frequency modulation circuit 210 includes a first amplifier 211, a second amplifier 221, a third amplifier 230 and a fourth amplifier 235. A positive input of the first amplifier 211 receives the level-shift signal V_{F}. A negative input of the first amplifier 211 receives a threshold V_{T1} via a resistor 212. An output of the first amplifier 211 is coupled to the negative input of the first amplifier 211 via a resistor 213. A positive input of the second amplifier 221 is coupled to the VA terminal. A negative input of the second amplifier 221 is coupled to its output to form a buffer circuit. One terminal of a current source 220 is coupled to the supply voltage V_{CC}. The other terminal of the current source 220 is coupled to an output of the second amplifier 221 via a resistor 224. A positive input of the third amplifier 230 is coupled to the output of the first amplifier 211 via a resistor 214. One terminal of a resistor 215 is coupled to the positive input of the third amplifier 230. The other terminal of the resistor 215 is coupled to the ground. A negative input of the third amplifier 230 is coupled to the other terminal of the current source 220 and its output via a resistor 225.

A positive input of the fourth amplifier 235 is coupled to the output of the third amplifier 230. A negative input of the fourth amplifier 235 is coupled to its output. The output of the fourth amplifier 235 is coupled to the RM terminal and generates the frequency modulation signal V_{M}. The modulation current I_{M} is supplied with the output of the fourth amplifier 235 and charges the RM terminal. When the level-shift signal V_{F} is higher than the threshold V_{T1}, the frequency modulation signal V_{M} will increase in response to the increase of the level-shift signal V_{F}. The frequency modulation circuit 210 further detects the input voltage V_{IN} through the VA terminal. When the voltage on the VA terminal is decreased and it is lower than a threshold provided by the current source 220, the frequency modulation signal V_{M} will be increased in response to the decrease of the input voltage V_{IN}.

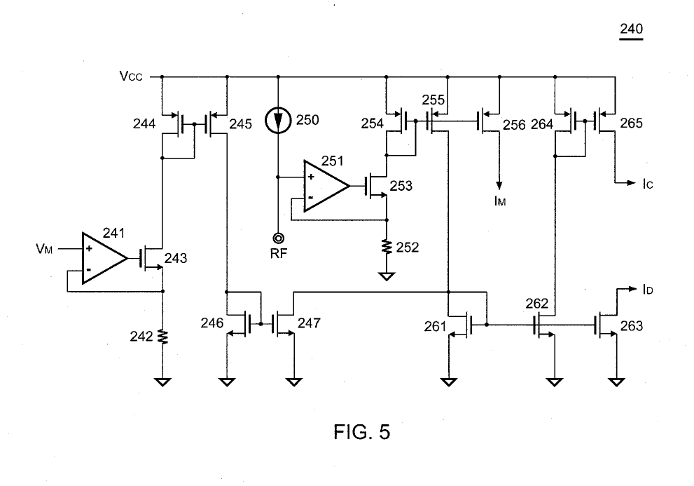

FIG. 5 shows a preferred embodiment of the frequency generation circuit 240 in accordance with the present invention. The frequency generation circuit 240 includes a first V-to-I converter, a second V-to-I converter, a current source 250, a first current-mirror formed by transistors 244 and 245, a second current-mirror formed by transistors 246 and 247, a third current-mirror formed by transistors 254 and 255, a fourth current-minor formed by transistors 254 and 256, a fifth current-minor formed by transistors 261 and 262, a sixth current-mirror formed by transistors 261 and 263 and a seventh current-mirror formed by transistors 264 and 265. The frequency generation circuit 240 generates the charge current I_{C} and the discharge current I_{D} in accordance with the resistor 51 (shown in FIG. 1) coupled to the RF terminal. The charge current I_{C} and the discharge current I_{D} are decreased in response to the increase of the frequency modulation signal V_{M}.

The first V-to-I converter includes an operational amplifier 241, a transistor 243 and a resistor 242. A positive input of the operational amplifier 241 receives the frequency modulation signal V_{M}. An output of the operational amplifier 241 is coupled to a gate terminal of the transistor 243. A negative input of the operational amplifier 241 is coupled to a source terminal of the transistor 243. The resistor 242 is connected from the source terminal of the transistor 243 to the ground. A drain terminal of the transistor 243 is coupled to the first current-minor. Source terminals of the transistors 244 and 245 of the first current-minor are coupled to the supply voltage V_{CC}. Gate terminals of the transistors 244, 245 and drain terminals of the transistors 244, 243 are connected together. A drain terminal of the transistor 245 is coupled to the second current-mirror. Source terminals of the transistors 246 and 247 of the second current-minor are coupled to the ground. Gate terminals of the transistors 246, 247 and drain terminals of the transistors 246, 245 are connected together. A drain terminal of the transistor 247 is coupled to the fifth current-mirror.

The second V-to-I converter includes an operational amplifier 251, a transistor 253 and a resistor 252. A positive input of the operational amplifier 251 is coupled to the current source 250. The current source 250 is further coupled to the supply voltage V_{CC}. The positive input of the operational amplifier 251 is further connected to the resistor 51 (shown in FIG. 1) coupled to the RF terminal. An output of the operational amplifier 251 is coupled to a gate terminal of the transistor 253. A negative input of the operational amplifier 251 is coupled to a source terminal of the transistor 253. The resistor 252 is connected from the source terminal of the transistor 253 to the ground. A drain terminal of the transistor 253 is coupled to the third current-mirror. Source terminals of the transistors 254 and 255 of the third current-mirror are coupled to the supply voltage V_{CC}. Gate terminals of the transistors 254, 255 and drain terminals of the transistors 254, 253 are connected together. A drain terminal of the transistor 255 is coupled to the fifth current-mirror.

A source terminal of the transistor 256 of the fourth current-mirror is coupled to the supply voltage V_{CC}. A gate terminal of the transistor 256 is coupled to the gate terminal of the transistor 254. A drain terminal of the transistor 256 generates the modulation current I_{M}. Source terminals of the transistors 261 and 262 of the fifth current-mirror are coupled to the ground. Gate terminals of the transistors 261, 262 and drain terminals of the transistors 261, 247, 255 are connected together. A drain terminal of the transistor 262 is coupled to the seventh current-mirror. A source terminal of the transistor 263 of the sixth current-mirror is coupled to the ground. A gate terminal of the transistor 263 is coupled to the gate terminal of the transistor 261. A drain terminal of the transistor 263 generates the discharge current I_{D}. Source terminals of the transistors 264 and 265 of the seventh current-mirror are coupled to the supply voltage V_{CC}. Gate terminals of the transistors 264, 265 and drain terminals of the transistors 264, 262 are connected together. A drain terminal of the transistor 265 generates the charge current I_{C}.

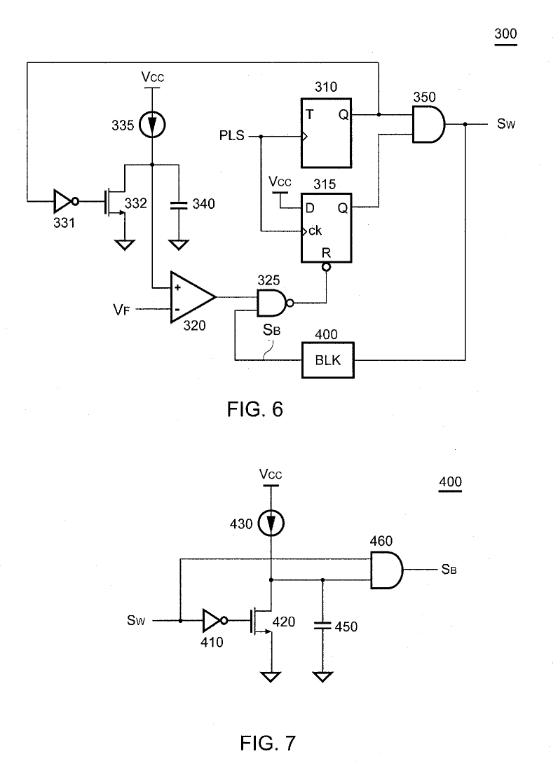

FIG. 6 is a preferred embodiment of the PWM circuit 300 in accordance with the present invention. The oscillation signal PLS is coupled to clock a T flip-flop 310 and a D flip-flop 315. A D-input of the D flip-flop 315 receives the supply voltage V_{CC}. An output Q of the T flip-flop 310 and an output Q of the D flip-flop 315 are connected to inputs of an AND gate 350 to generate the PWM signal S_{W}. The T flip-flop 310 provides a 50% maximum duty cycle for the PWM signal S_{W}. The output of the T flip-flop 310 is further connected to an input of an inverter 331. The inverter 331, a transistor 332, a current source 335 and a capacitor 340 develop a ramp generator to generate a ramp signal in response to the enable of the output of the T flip-flop 310.

One terminal of the current source 335 is coupled to the supply voltage V_{CC}. Other terminal of the current source 335 is coupled to a first terminal of the capacitor 340. A second terminal of the capacitor 350 is coupled to the ground. A drain terminal of the transistor 332 is coupled to the first terminal of the capacitor 340. A source terminal of the transistor 332 is coupled to the ground. A gate terminal of the transistor 332 is coupled to an output of the inverter 331. When the output of the T flip-flop 310 is enabled, the current source 335 charges the capacitor 340. When the output of the T flip-flop 310 is disabled, the capacitor 340 is discharged through the transistor 332 and the ground. Therefore, the ramp signal is generated at the capacitor 340.

The ramp signal is coupled to a positive input of a comparator 320. The level-shift signal V_{F} is supplied with a negative input of the comparator 320. The ramp signal is coupled to the comparator 320 to compare with the level-shift signal V_{F} and generate a PWM-reset signal. Through an NAND gate 325, the PWM-reset signal is coupled to a reset-input R of the D 315 to reset the D flip-flop 315 and achieve the pulse width modulation of the PWM signal S_{W}. A blanking circuit (BLK) 400 is coupled to the PWM signal S_{W} to generate a blanking signal S_{B} in response to the enable of the PWM signal S_{W}. The blanking signal S_{B} is connected to the NAND gate 325 to inhibit the reset of the D flip-flop 315, which ensures a minimum on time of the PWM signal S_{W}.

FIG. 7 shows a preferred embodiment of the blanking circuit 400 in accordance with the present invention. The blanking circuit 400 includes a charge current 430, an inverter 410, a transistor 420, a capacitor 450 and an AND gate 460. The transistor 420 can be the N-type transistor in accordance with one embodiment of the present invention. A gate terminal of the N-type transistor 420 receives the PWM signal S_{W} via the inverter 410. A first input of the AND gate 460 receives the PWM signal S_{W} as well. A source terminal of the N-type transistor 420 is coupled to the ground. A second input of the AND gate 460 is coupled to a drain terminal of the N-type transistor 420 and one terminal of the capacitor 450. The drain terminal of the N-type transistor 420 is coupled to the supply voltage V_{CC} via the charge current 430. The other terminal of the capacitor 450 is coupled to the ground. An output of the AND gate 460 generates the blanking signal S_{B}. Therefore, the blanking circuit 400 receives the PWM signal S_{W} to generate the blanking signal S_{B} in response to the enable of the PWM signal S_{W}. The blanking time is determined by the capacitance of the capacitor 450 and the current of the charge current 430.

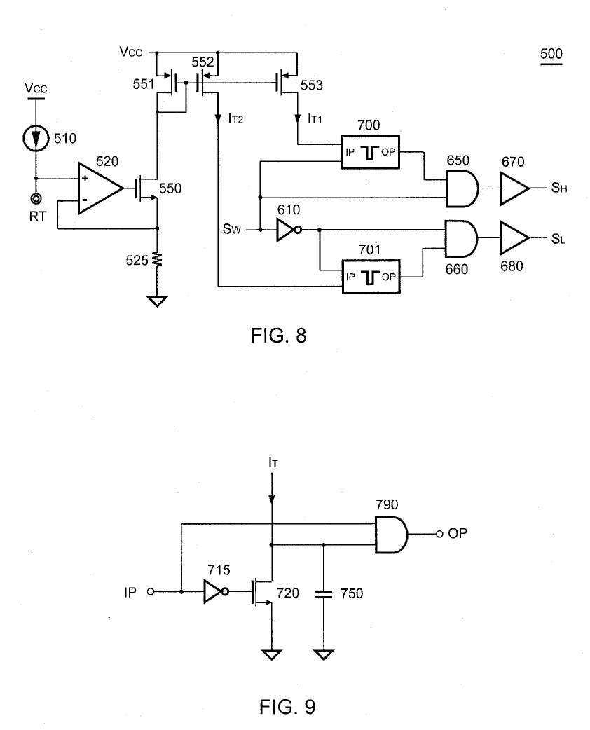

FIG. 8 is a preferred embodiment of the output circuit 500 in accordance with the present invention. The resistor 53 (shown in FIG. 1) associated with a current source 510 generates a voltage on the RT terminal. The current source 510 is coupled from the supply voltage V_{CC} to the resistor 53 through RT terminal. The voltage of the RT terminal is connected to a positive input of an operational amplifier 520. The operational amplifier 520, a resistor 525 and a transistor 550 form a voltage-to-current converter that generates a current coupled to transistors 551, 552, 553. A positive input of the operational amplifier 520 receives the voltage of the RT terminal. An output of the operational amplifier 520 is coupled to a gate terminal of the transistor 550. A negative input of the operational amplifier 520 is coupled to a source terminal of the transistor 550. The resistor 525 is connected from the source terminal of the transistor 550 to the ground. A drain terminal of the transistor 550 generates the current coupled to the transistors 551, 552, 553.

Transistors 551, 552 and 553 develop two current mirrors generating currents I_{T1} and I_{T2} coupled to delay time circuits 700 and 701 respectively. Source terminals of the transistors 551, 552 and 553 are coupled to the supply voltage V_{CC}. Gate terminals of the transistors 551, 552, 553 and drain terminals of the transistors 551, 550 are connected together. A drain terminal of the transistor 553 generates the current I_{T1} coupled to an input of the delay time circuit 700. A drain terminal of the transistor 552 generates the current I_{T2} coupled to an input of the delay time circuit 701. The delay time circuits 700 and 701 generate the delay times for the switching signals S_{H}, S_{L}. The PWM signal S_{W} is connected to the delay time circuit 700 and an input of an AND gate 650. The output of the delay time circuit 700 is connected to another input of the AND gate 650. An output of the AND gate 650 is connected to a buffer 670 to generate the switching signal S_{H}. In response to the enable of the PWM signal S_{W}, the switching signal S_{H} is generated after the delay time produced by the delay time circuit 700.

Furthermore, through an inverter 610, the PWM signal S_{W} is connected to the delay time circuit 701 and an input of an AND gate 660. The output of the delay time circuit 701 is connected to another input of the AND gate 660. An output of the AND gate 660 is connected to a buffer 680 to generate the switching signal S_{L}. In response to the disabling of the PWM signal S_{W}, the switching signal S_{L} is generated after the delay time is produced by the delay time circuit 701.

FIG. 9 shows a preferred embodiment of delay time circuits 700 and 701 in accordance with the present invention. The delay time circuit includes a charge current I_{T}, an inverter 715, a transistor 720, a capacitor 750 and an AND gate 790. The charge current I_{T} means currents I_{T1} or I_{T2} shown in FIG. 8. The transistor 720 can be the N-type transistor in accordance with one embodiment of the present invention. A gate terminal of the N-type transistor 720 receives an input signal IP via the inverter 715. For the input of the delay time circuit 700 (shown in FIG. 8), the input signal IP means the PWM signal S_{W}. For the input of the delay time circuit 701 (shown in FIG. 8), the input signal IP also means the PWM signal S_{W} but it needs to pass through the inverter 610. A first input of the AND gate 790 receives the input signal IP as well. A source terminal of the N-type transistor 720 is coupled to the ground. A second input of the AND gate 790 is coupled to a drain terminal of the N-type transistor 720 and one terminal of the capacitor 750. The drain terminal of the N-type transistor 720 is coupled to the charge current I_{T}. The other terminal of the capacitor 750 is coupled to the ground. An output of the AND gate 790 generates an output signal OP. Therefore, the delay time circuit receives the input signal IP to generate the output signal OP (delay time) in response to the enable of the input signal IP. The delay time is determined by the capacitance of the capacitor 750 and the current of the charge current I_{T}.

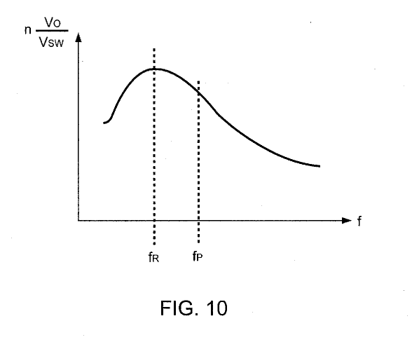

FIG. 10 is a transfer function chart that shows the gain versus the change of the switching frequency. The voltage V_{SW} is the voltage across the transistor 20 (shown in FIG. 1). It is the input voltage of the resonant tank. The n is the turn ratio of the transformer 30 (shown in FIG. 1). The frequency fₚ is the maximum switching frequency of the switching signals S_{H} and S_{L}. The minimum pulse width of the switching signal S_{H} must provide enough energy and circulating current to achieve soft switching of the transistors 10 and 20. The frequency f_{R} is resonant frequency of the resonant tank. The minimum switching frequency of the switching signals S_{H} and S_{L} should be higher than and close to the resonant frequency f_{R} in order to achieve the soft switching and the maximum power transfer. It shows the decrease of the switching frequency from the frequency fₚ to the frequency f_{R} when the input voltage is decreased and/or the load is increased, which will extend the operation range and improve the efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A soft switching power converter comprising:
a resonant tank;
a plurality of transistors coupled to switch the resonant tank; and
a control circuit generating a plurality of switching signals to control the transistors, wherein the pulse widths of the switching signals are modulated for regulating an output voltage of the power converter, the control circuit is coupled to detect an input voltage of the power converter, the frequency of the switching signals is changed in response to the change of the input voltage.

2. The soft switching power converter as claimed in claim 1, wherein the resonant tank includes a capacitor and an inductive device, the capacitor is coupled to the inductive device.

3. The soft switching power converter as claimed in claim 1, wherein the control circuit further generates a plurality of delay times inserted between the switching signals to achieve soft switching.

4. The soft switching power converter as claimed in claim 3, further comprising a delay-time resistor coupled to the control circuit for determining the delay times of the switching signals.

5. The soft switching power converter as claimed in claim 1, wherein the frequency of the switching signals is decreased in response to the decrease of the input voltage.

6. The soft switching power converter as claimed in claim 1, wherein the frequency of the switching signals is decreased in response to the increase of an output load of the power converter.

7. The soft switching power converter as claimed in claim 1, further comprising a frequency-setting resistor coupled to the control circuit for determining a maximum switching frequency of the switching signals.

8. The soft switching power converter as claimed in claim 1, further comprising a frequency-modulation resistor coupled to the control circuit for determining a minimum switching frequency of the switching signals.

9. The soft switching power converter as claimed in claim 1, wherein the control circuit comprising:
an oscillator coupled to detect the input voltage and a feedback signal for generating an oscillation signal;
a PWM circuit generating a PWM signal in response to the oscillation signal, the pulse width of the PWM signal being modulated by the PWM circuit in accordance with the feedback signal; and
an output circuit generating the switching signals in accordance with the PWM signal, a plurality of delay times being inserted into the switching signals for achieving soft switching of the transistors.

10. The soft switching power converter as claimed in claim 9, wherein the control circuit further comprising:
a feedback-input circuit coupled to an output of the power converter to receive the feedback signal for generating a level-shift signal, the oscillator receiving the level-shift signal to detect the feedback signal for generating the oscillation signal, and the PWM circuit receiving the level-shift signal to modulate the pulse width of the PWM signal in accordance with the feedback signal.

11. The resonant power converter as claimed in claim 9, wherein the oscillator comprises:
a frequency modulation circuit generating a frequency modulation signal in accordance with the feedback signal and the input voltage;
a frequency generation circuit generating a charge current and a discharge current in accordance with a frequency-setting resistor and the frequency modulation signal, the frequency-setting resistor coupled to the control circuit for determining a maximum switching frequency of the switching signals; and
an oscillation circuit coupled to receive the charge current and the discharge current for generating the oscillation signal.

12. A power converter comprising:
a resonant tank;
a plurality of transistors coupled to switch the resonant tank; and
a control circuit generating a plurality of switching signals to control the transistors, wherein the pulse widths of the switching signals are modulated for regulating an output voltage of the power converter;
wherein the frequency of the switching signals is changed in response to the change of an output load of the power converter.

13. The power converter as claimed in claim 12, wherein the control circuit is coupled to detect the output load of the power converter, the frequency of the switching signals is decreased in response to the increase of the output load of the power converter.

14. The power converter as claimed in claim 12, wherein the control circuit is coupled to detect an input voltage of the power converter, the frequency of the switching signals is changed in response to the change of the input voltage.

15. The power converter as claimed in claim 14, wherein the frequency of the switching signals is decreased in response to the decrease of the input voltage.

16. The power converter as claimed in claim 12, wherein the resonant tank includes a capacitor and an inductive device, the capacitor is coupled to the inductive device.

17. The power converter as claimed in claim 12, further comprising a frequency-setting resistor coupled to the control circuit for determining a maximum switching frequency of the switching signals.

18. The power converter as claimed in claim 12, further comprising a frequency-modulation resistor coupled to the control circuit for determining a minimum switching frequency of the switching signals.

19. The power converter as claimed in claim 12, wherein the control circuit comprising:
an oscillator coupled to detect an input voltage and a feedback signal for generating an oscillation signal;
a PWM circuit generating a PWM signal in response to the oscillation signal, the pulse width of the PWM signal being modulated by the PWM circuit in accordance with the feedback signal;
an output circuit generating the switching signals in accordance with the PWM signal.

20. The power converter as claimed in claim 19, wherein the control circuit further comprising:
a feedback-input circuit coupled to an output of the power converter to receive the feedback signal for generating a level-shift signal, the oscillator receiving the level-shift signal to detect the feedback signal for generating the oscillation signal, and the PWM circuit receiving the level-shift signal to modulate the pulse width of the PWM signal in accordance with the feedback signal.

21. The power converter as claimed in claim 19, wherein the oscillator comprising:
a frequency modulation circuit generating a frequency modulation signal in accordance with the feedback signal and the input voltage;
a frequency generation circuit generating a charge current and a discharge current in accordance with a frequency-setting resistor and the frequency modulation signal, the frequency-setting resistor coupled to the control circuit for determining a maximum switching frequency of the switching signals;
an oscillation circuit coupled to receive the charge current and the discharge current for generating the oscillation signal.

22. The power converter as claimed in claim 12, wherein the control circuit further generates a plurality of delay times inserted between the switching signals to achieve soft switching.

23. The power converter as claimed in claim 22, further comprising a delay-time resistor coupled to the control circuit for determining the delay times of the switching signals.
